(19) United States
(12) Patent Application Publication
(10) Pub. No.: US 2014/0169733 A1
(43) Pub. Date: Jun. 19, 2014

(54) OPTICAL MODULE

(71) Applicant: HON HAI PRECISION INDUSTRY CO., LTD., New Taipei (TW)

(72) Inventors: GENN-SHENG LEE, New Taipei (TW); YU-HUNG YEN, New Taipei (TW)

(73) Assignee: HON HAI PRECISION INDUSTRY CO., LTD., New Taipei (TW)

(21) Appl. No.: 14/106,877

(22) Filed: Dec. 16, 2013

(30) Foreign Application Priority Data
Dec. 14, 2012 (TW) 101147340

(51) Int. Cl. G02B 6/35

(52) U.S. Cl. CPC G02B 6/354
USPC 385/17; 385/16

(57) ABSTRACT

An optical module includes a first switch card (10) having a first optical connector, a second switch card (20) disposed on a side of the first switch card and having a second optical connector, a number of line cards (30) disposed on an opposite side of the first switch card, each of the line cards having a third optical connector, and an optical interconnect assembly having a single fourth optical connector (41) mated with the first optical connector, a single fifth optical connector (45) mated with the second optical connector, a number of sixth optical connectors (43) mated with the third optical connectors, respectively, a number of stacked first optical waveguides (44) connected with the single fourth optical connector and each of the sixth optical connectors, and a number of stacked second optical waveguides connected with the single fifth optical connector and each of the sixth optical connectors.

### BACKGROUND OF THE INVENTION

1. Field of the invention

The present invention generally relates to an optical module, and more particularly relates to a connection structure between switch cards and line cards.

2. Description of Related Art

U.S. Patent Application Publication No. 2012/0308188, published on Dec. 6, 2012, to Chien et al. discloses an optical backplane system. The optical backplane system comprises a backplane, a pair of switch cards mounted to the backplane, and a plurality of line cards mounted to the backplane and disposed parallel to the switch cards. All of the switch and the line cards comprise a plurality of vertically spaced optical connecting portions. The optical backplane system further comprises an optical connecting member to couple the optical connecting portions of the line cards with the optical connecting portions of the switch cards. However, a number of vertically spaced optical connecting portions may occupy a lot of space on the surface of the backplane.

Hence, an improved optical module is desired to offer advantages over the related art.

### SUMMARY OF THE INVENTION

Accordingly, an object of the present invention is to provide an optical module that achieves interconnection of switch cards and line cards through novel arrangement of optical connectors and waveguides.

In order to achieve the above-mentioned object, an optical module comprises a first switch card comprising a first optical connector; a second switch card disposed on a side of the first switch card and comprising a second optical connector; a plurality of line cards disposed on an opposite side of the first switch card, each of the line cards comprising a third optical connector; and an optical interconnect assembly comprising a single fourth optical connector mated with the first optical connector, a single fifth optical connector mated with the second optical connector, a plurality of sixth optical connectors mated with the third optical connectors, respectively, a plurality of stacked first optical waveguides connected with the single fourth optical connector and each of the sixth optical connectors, and a plurality of stacked second optical waveguides connected with the single fifth optical connector and each of the sixth optical connectors.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an optical module in accordance with the present invention;

FIG. 2 is a top view of the optical module as shown in FIG. 1;

FIG. 3 is a side view of the optical module as shown in FIG. 1;

FIG. 4 is a perspective view of an optical interconnect assembly of the optical module as shown in FIG. 1;

FIG. 5 is another perspective view of the optical interconnect assembly as shown in FIG. 4; and

FIG. 6 is another perspective view of the optical interconnect assembly as shown in FIG. 4.

### DETAILED DESCRIPTION OF THE PREFERRED EMBODIMENT

Reference will now be made to the drawing figures to describe the present invention in detail.

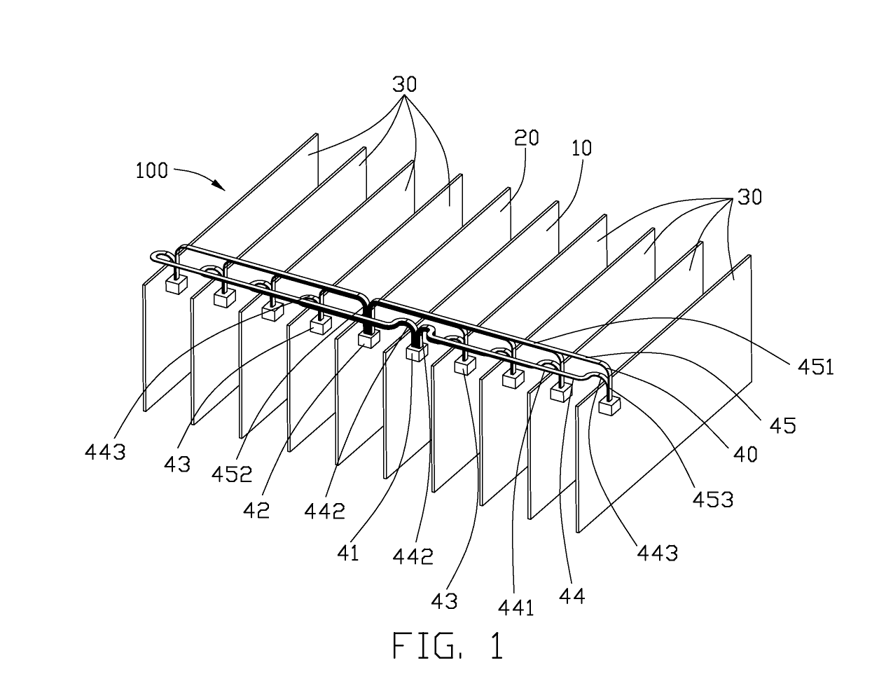

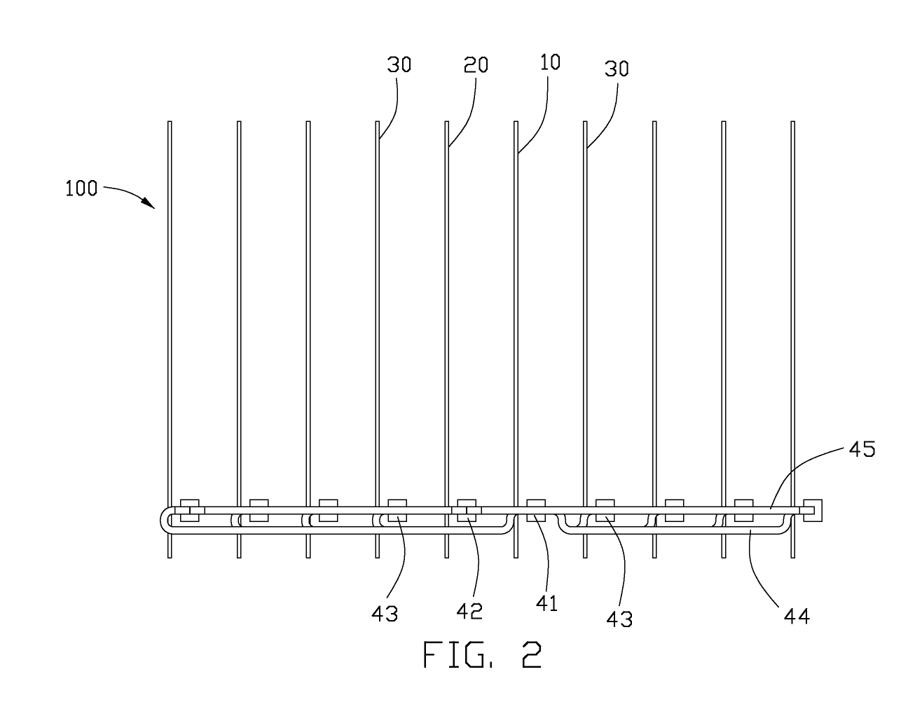

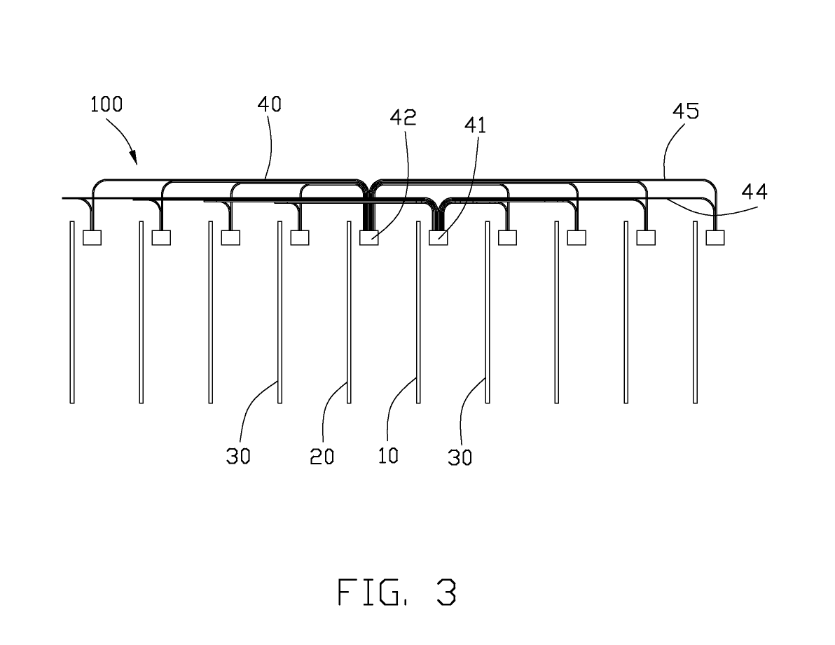

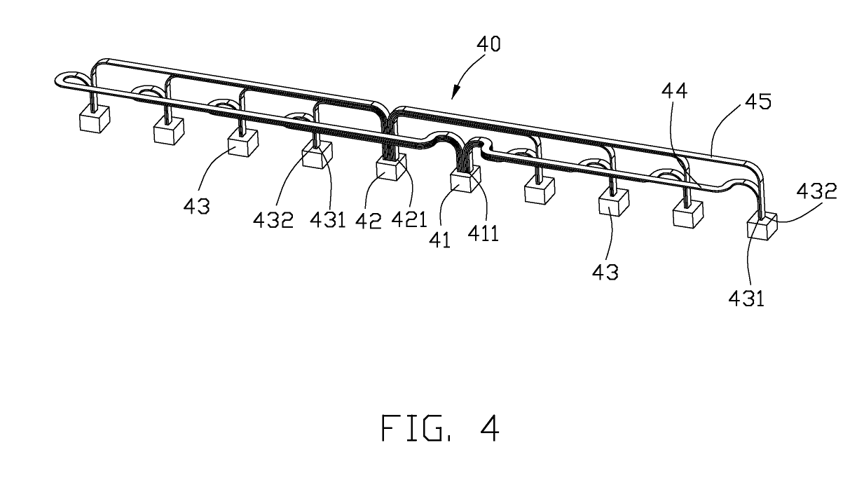

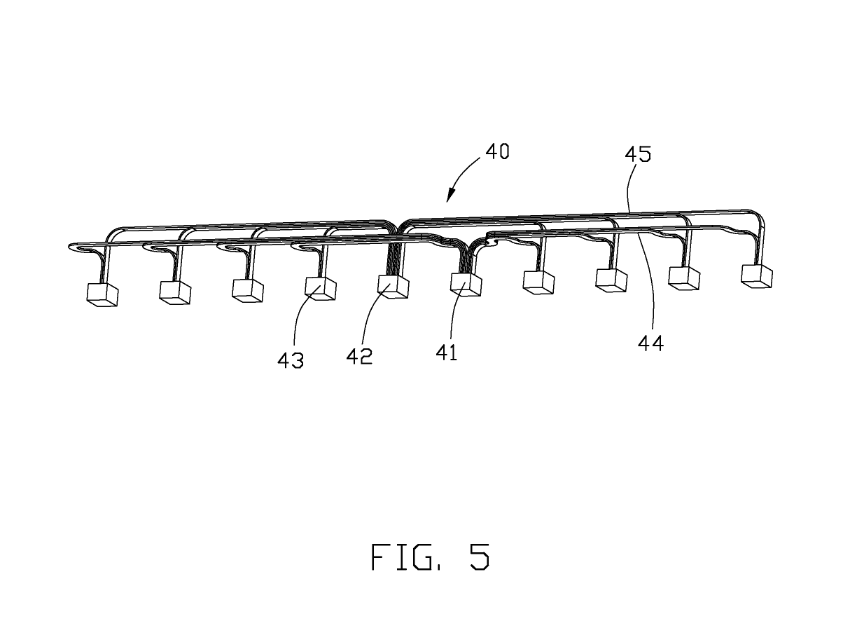

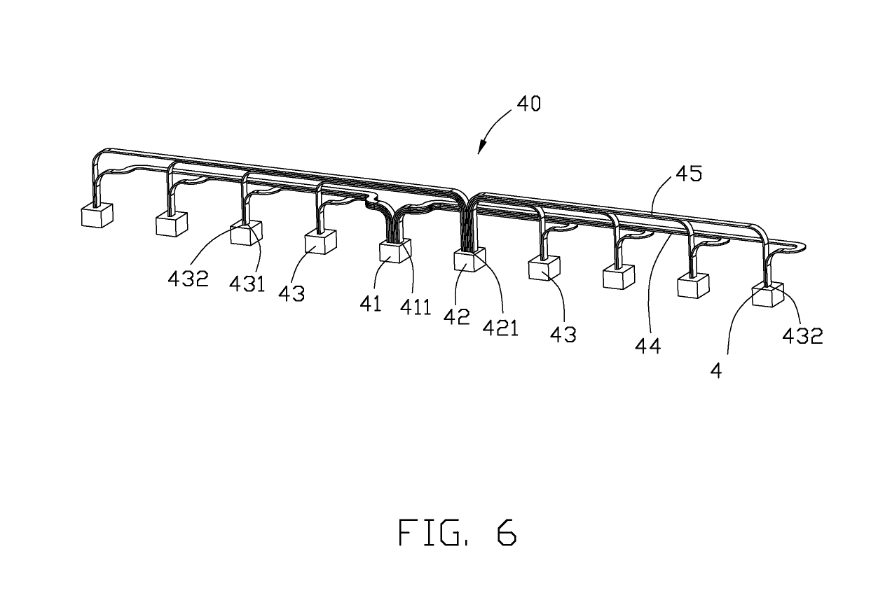

Referring to FIGS. 1 to 6, the optical module 100 comprises a first switch card 10, a second switch card 20 disposed on a side of the first switch card 10, a plurality of line cards 30 disposed on an opposite side of the first switch card 10, and an optical innterconnect assembly 40 connecting the first switch card 10 with the second switch card 20 and each line card 30. The optical module 100 further comprises a plurality of line cards 30 disposed on a side of the second switch card 20. The optical interconnect assembly 40 connects the line card 30 with the first switch card 10 and the second switch card 20. The first switch card 10, the second switch card 20, and the line cards 30 are disposed spaced apart from and parallel to each other.

The first switch card 10 comprises a first optical connector (not shown). The second switch card 20 comprises a second optical connector (not shown). Each of the line cards 30 has a third optical connector (not shown). The optical interconnect assembly 40 comprises a single fourth optical connector 41 connected with the first optical connector, a single fifth optical connector 42 connected with the second optical connector, plural sixth optical connectors 43 connected with the third optical connectors, respectively, a plurality of stacked first optical waveguides 44 connecting the single fourth optical connector 41 with each sixth optical connector 43, and a plurality of stacked second optical waveguides 45 connecting the single fifth optical connector 42 with each sixth optical connector 43. The first optical connector and the second optical connector have same configuration. The third optical connectors of the line cards 30 have same configuration as well. However, the configuration of the third optical connector is different from the configuration of the first optical connector and the second optical connector.

Referring to FIGS. 1 to 6, the first optical waveguide 44 and the second optical waveguide 45 may be optical fibers or other materials suitable for optical signal transmission. In this embodiment, the first optical waveguide 44 and the second optical waveguide 45 are manufactured by polymer material. Each of the first optical waveguide 44 and the second optical waveguide 45 defines a plurality of optical channels (not labeled). Each of the first optical waveguides 44 comprises a body portion 441 extending along a direction toward the sixth optical connector 43 from the single fourth optical connector 41, a first connecting portion 442 bended from an end of the body portion 441 and connected with the single fourth optical connector 41, a second connecting portion 443 bended from an opposite end of the body portion 441 and connected with the sixth optical connector 43. The body portions 441 of the first optical waveguides 44 are stacked on a same vertical plane along vertical direction. The first and the second connecting portions 442 and 443 are located outside of the vertical plane. Each of the second optical waveguide 45 comprises a body portion 451 extended along a direction of the sixth optical connector 43 from the single fifth optical connector 42, a first connecting portion 452 bended from an end of the body portion 451 and connected with the single fifth optical connector 42, a second connecting portion 453 bended from the other end of the body portion 451 and connected with the sixth optical connector 43. The body portions 451 of the second optical waveguides 45 are stacked on a first vertical plane along a vertical direction. Each of the first optical waveguides 44 is disposed on a side of the second optical waveguide 45 by the first and the second connecting portions 442 and 443 bended and extended to the side of the first optical waveguide 44 and stacked on a second vertical plane parallel to the first vertical plane.

Each of the sixth optical connector 43 comprises a first connecting area 431 and a second connecting area 432. A distance between the second connecting area 432 and the first switch card 10 is greater than a distance between the first connecting area 431 and the first switch card 10. The first optical waveguide 44 connects with the first connecting areas 431 of the line cards 30 which are disposed at a side of the first switch card 10. The first optical waveguide 44 connects with the second connecting areas 432 of the line cards 30 which are disposed at an opposite side of the first switch card 10. The second optical waveguide 45 connects with remaining second connecting area 432 or remaining first connecting area 431 of the line cards 30. The number of connecting areas 411 of the single fourth optical connector 41 is equal to the number of sixth optical connectors 43. The connecting area 411 is arranged along a direction that the line cards 30 are arranged. The nearest connecting area 411 adjacent to the line cards 30 connects, by way of the first optical waveguide 44, with the line card 30 which is the nearest to the first switch card 10. The second nearest connecting area 411 adjacent to the line cards 30 connects with the line card 30 which is the second nearest adjacent to the first switch card 10. The other connecting areas are similarly connected to respective line cards through the first optical waveguides 44. The number of connecting areas 421 of the single fifth optical connector 42 is equal to the number of sixth optical connectors 43. The connecting area 421 is arranged along a direction of the line card 30 arrangement. The connecting area 421 nearest to the line card 30 connects with the line card 30 which is the nearest to the second switch card 20 by the second optical waveguide 45, the second nearest connecting area 421 to the line card 30 connects with the line card 30 which is the second nearest to the second switch card 20 by the second optical waveguide 45, etc.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. An optical module comprising:
a first switch card comprising a first optical connector;
a second switch card disposed on a side of the first switch card and comprising a second optical connector;
a plurality of line cards disposed on an opposite side of the first switch card, each of the line cards comprising a third optical connector; and
an optical interconnect assembly comprising a single fourth optical connector mated with the first optical connector, a single fifth optical connector mated with the second optical connector, a plurality of sixth optical connectors mated with the third optical connectors, respectively, a plurality of stacked first optical waveguides connected with the single fourth optical connector and each of the sixth optical connectors, and a plurality of stacked second optical waveguides connected with the single fifth optical connector and each of the sixth optical connectors.

2. The optical module as claimed in claim 1, wherein all of the second optical waveguides are stacked on a first vertical plane, and each of the first optical waveguides is bended and extended to a side of the second optical waveguide and is stacked on a second vertical plane parallel to the first vertical plane.

3. The optical module as claimed in claim 1, wherein the single fourth optical connector comprises a plurality of connecting areas, the number of connecting areas of the single fourth optical connector being equal to the number of the sixth optical connectors, and the connecting areas are arranged along an arrangement direction of the line cards.

4. The optical module as claimed in claim 3, wherein the connecting area of the single fourth optical connector nearest to the line cards is connected with the line card nearest to the first switch card by the first optical waveguide.

5. The optical module as claimed in claim 1, wherein each of the sixth optical connectors defines a first connecting area and a second connecting area, the first optical waveguides connected with the first connecting areas and the second optical waveguides connected with the second connecting areas.

6. The optical module as claimed in claim 5, wherein a distance between the second connecting area and the first switch card is greater than a distance between the first connecting area and the first switch card.

7. The optical module as claimed in claim 1, wherein each of the first and the second optical waveguides comprises a plurality of optical channels.

8. The optical module as claimed in claim 1, wherein the first switch card, the second switch card, and the line cards are disposed spaced apart from and parallel to each other.

9. The optical module as claimed in claim 1, further comprising a plurality of line cards, on a side of the second switch card opposite to the first switch card, connected with the first switch card and the second switch card by the optical interconnect assembly.

10. An optical module comprising:
M switch optical connectors side by side arranged one another, each of said switch optical connectors defining N ports, wherein M and N are integers and not less than 2;
N line optical connectors generally equally divided into two groups to be respectively located by two sides of said M switch optical connectors, the line optical connectors, in each group, being side by side arranged with one another, each of said line optical connector defining M ports; and
M×N waveguides or optical fibers each defining one end connected to one corresponding switch optical connector and the other end connected to one corresponding line optical connector.

11. The optical module as claimed in claim 10, wherein each of said switch optical connectors and each of said line optical connectors is mounted to a card, and all cards are arranged in a parallel relation.

12. The optical module as claimed in claim 10, wherein the waveguides or optical fibers connected to the same switch optical connector, is divided into two groups corresponding to said two groups of the line optical connectors, and said waveguides in each group are initially stacked with one another before being split to reach the corresponding line optical connector.

13. The optical module as claimed in claim 12, wherein each of said switch optical connectors and each of said line optical connectors is mounted to a card, and all cards are arranged in a parallel relation, and the stacked waveguides extend in a direction perpendicular to said cards.

14. The optical module as claimed in claim 13, wherein the stacked waveguides in the different groups are located at different levels.

15. The optical module as claimed in claim 14, where said levels are measured along in vertical direction along which the connected waveguides or optical fibers extends from the corresponding connector, said vertical direction being perpendicular to said transverse direction.

16. The optical module as claimed in claim 10, wherein the waveguides or optical fibers in each group have different lengths.

17. An optical module comprising:
a plurality of cards side by side arranged with one another along a transverse direction; and
a plurality of optical connectors mounted to the corresponding cards wherein the center two optical connectors are switch optical connectors and the remaining optical connectors are line optical connectors; wherein
each of said switch optical connectors is equipped with a plurality of waveguides or optical fibers divided into two groups to connect to the corresponding line optical connectors by two sides thereof in said transverse direction.

18. The optical module as claimed in claim 17, wherein each of said connectors is mounted in a same surface and a same position with regard to each corresponding card.

19. The optical module as claimed in claim 17, wherein there are totally M optical connectors and M×(M−2) waveguides or optical fibers.

20. The optical module as claimed in claim 17, wherein the waveguides are stacked with one another in a vertical direction along which the connected waveguides extends from the corresponding connector, said vertical direction being perpendicular to said transverse direction.
